(19) United States
(12) Patent Application Publication
(10) Pub. No.: US 2025/0130307 A1
(43) Pub. Date: Apr. 24, 2025

(54) INDOOR MIMO ACOUSTIC DETECTION AND LOCALIZATION USING TONE SIGNALS

(71) Applicant: NEC Laboratories America, Inc., Princeton, NJ (US)

(72) Inventors: Jian FANG, Princeton, NJ (US); Wataru KOHNO, Princeton, NJ (US); Yaowen LI, Princeton, NJ (US); Ting WANG, West Windsor, NJ (US)

(73) Assignee: NEC Laboratories America, Inc., Princeton, NJ (US)

(21) Appl. No.: 18/901,760

(22) Filed: Sep. 30, 2024

Related U.S. Application Data
(60) Provisional application No. 63/592,677, filed on Oct. 24, 2023.

(51) Int. Cl. G01S 5/22

(52) U.S. Cl. CPC G01S 5/22

(57) ABSTRACT

Disclosed are systems and methods directed to a MIMO method that detects and localizes an object without requiring the object to emit a sound. Operationally, multiple speakers generate tone signals at different frequencies, while multiple acoustic sensors demodulate the complex amplitude of each frequency. By monitoring the feature variation of the relative phase (or intensity) vector from the complex amplitude, our method detects or localizes movement of the object. For large-scale applications, a fiber-optic system and method that employs distributed acoustic sensing (DAS) in which an optical fiber is used as one or more acoustic sensors located at points along the length of the optical fiber. A single DAS system provides numerous sensors using only a single optical fiber thereby enabling perfect synchronization and centralized signal processing. Notably, with such a DAS arrangement, cost and complexity is significantly reduced, while privacy is preserved.

### CROSS-REFERENCE TO RELATED APPLICATIONS

This application claims the benefit of U.S. Provisional Patent Application Ser. No. 63/592,677 filed Oct. 24, 2023, the entire contents of which is incorporated by reference as if set forth at length herein.

### FIELD OF THE INVENTION

This application relates generally to indoor acoustic localization. More particularly, it pertains to indoor Multiple-Input, Multiple-Output (MIMO) acoustic detection and localization using tone signals that may advantageously detect a silent object.

### BACKGROUND OF THE INVENTION

Generally, conventional indoor sound localization techniques cannot detect a silent object and exhibit relatively poor performance when used to localize an object emitting a continuous single tone due to reflections and diffusions.

### SUMMARY OF THE INVENTION

An advance in the art is made according to aspects of the present disclosure directed to a MIMO method that detects and localizes an object without requiring the object to emit a sound.

In sharp contrast to the prior art and according to aspects of the present disclosure, multiple speakers generate tone signals at different frequencies, while multiple acoustic sensors demodulate the complex amplitude of each frequency. By monitoring the feature variation of the relative phase (or intensity) vector from the complex amplitude, our inventive method detects or localizes movement of the object.

For large-scale applications, we also describe a fiber-optic system and method that employs distributed acoustic sensing (DAS). With this inventive configuration, an optical fiber is used as one or more acoustic sensors located at points along the length of the optical fiber. As such, a single DAS system provides numerous sensors using only a single optical fiber thereby enabling perfect synchronization and centralized signal processing. Notably, with such a DAS arrangement, cost and complexity is significantly reduced, while privacy is preserved.

### BRIEF DESCRIPTION OF THE DRAWING

FIG. 1 is a schematic flow diagram showing an illustrative method according to aspects of the present disclosure.

FIG. 2(A), and FIG. 2(B) are a series of schematic diagrams showing an illustrative propagation of sound in: FIG. 2(A), a vacant room; and FIG. 2(B), a room with an object to detect, according to aspects of the present disclosure.

FIG. 3 is a schematic diagram showing an illustrative MIMO scheme for silent-object detection using multiple tones according to aspects of the present disclosure.

FIG. 4 is a schematic block diagram showing an illustrative structure of a DAS system according to aspects of the present disclosure.

FIG. 5 is a schematic diagram showing an illustrative top view of an indoor object detection/localization scheme for multiple rooms according to aspects of the present disclosure.

FIG. 6 is a schematic diagram with photo-illustration showing an illustrative setup for our preliminary experiments on systems and methods according to aspects of the present disclosure.

FIG. 7(A) and FIG. 7(B) show correlograms of relative phases with 500 Hz tone @ speaker R according to aspects of the present disclosure.

FIG. 8 shows correlograms of relative phases with 300-Hz tone @ speaker M according to aspects of the present disclosure.

FIG. 9(A), FIG. 9(B), FIG. 9(C), and FIG. 9(D) are a series of correlograms in which; FIG. 9(A) is for Speaker R 500-Hz only; FIG. 9(B) is for Speaker R 300-Hz only; FIG. 9(C) is for both Speakers, 500-Hz filtered; and FIG. 9(D) is for both Speakers, 300-Hz filtered; according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

As noted previously, we disclose herein a new method for the indoor localization of a silent object. As is known, conventional, contemporary indoor sound localization techniques cannot detect a silent object and exhibit poor performance when localizing an object emitting continuous single tone due to reflections and diffusions. In sharp contrast, we now disclose a MIMO method and system to detect and localize an object without requiring that object to emit a sound.

Multiple speakers generate tone signals at different frequencies, while multiple acoustic sensors demodulate the complex amplitude of each frequency. By monitoring the feature variation of the relative phase (or intensity) vector from the complex amplitude, our inventive systems and methods detect and/or localize movement of such silent objects or one that emits a continuous single tone.

For large-scale applications, we also describe herein a fiber-optic solution to these problems based on DAS. In a DAS application, the optical fiber acts as a plurality of acoustic sensors, and a single DAS system supports numerous sensors located along the length of the fiber thereby enabling perfect synchronization and centralized signal processing. As will be greatly appreciated, the cost and complexity of systems and methods according to the present disclosure are significantly reduced, while privacy is preserved.

As will become readily apparent and greatly appreciated by those skilled in the art, inventive features of systems and methods according to aspects of the present disclosure include the following.

First, our inventive method of using multiple tone signals and multiple acoustic sensors for silent object detection and localization in an indoor environment.

Second, our inventive signal processing method and steps employed that detect and localize the object in a room.

Finally, our inventive method which uses distributed fiber-optic sensing/distributed acoustic sensing (DFOS/DAS) to detect and localize silent objects over a large coverage area.

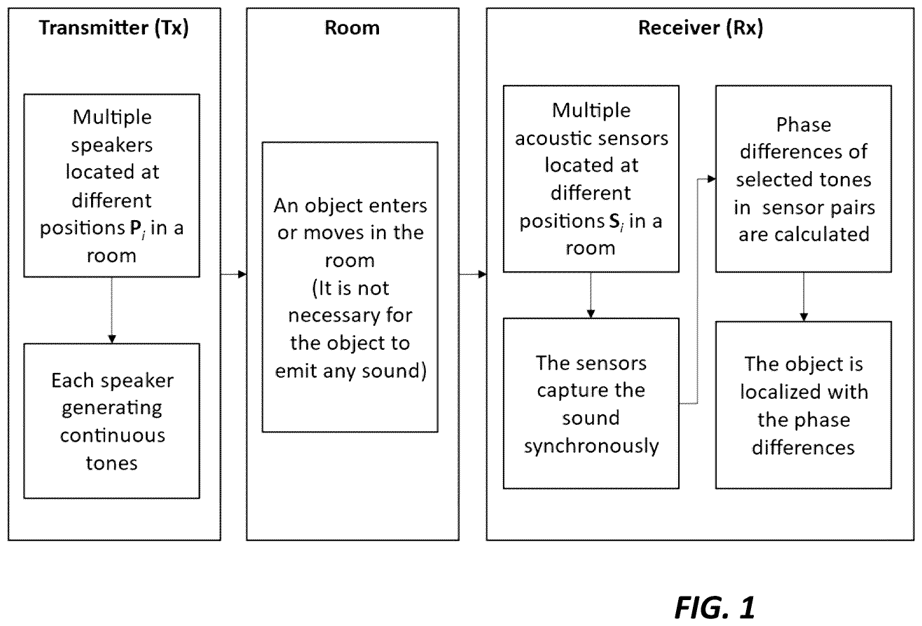

FIG. 1 is a schematic flow diagram showing an illustrative method according to aspects of the present disclosure.

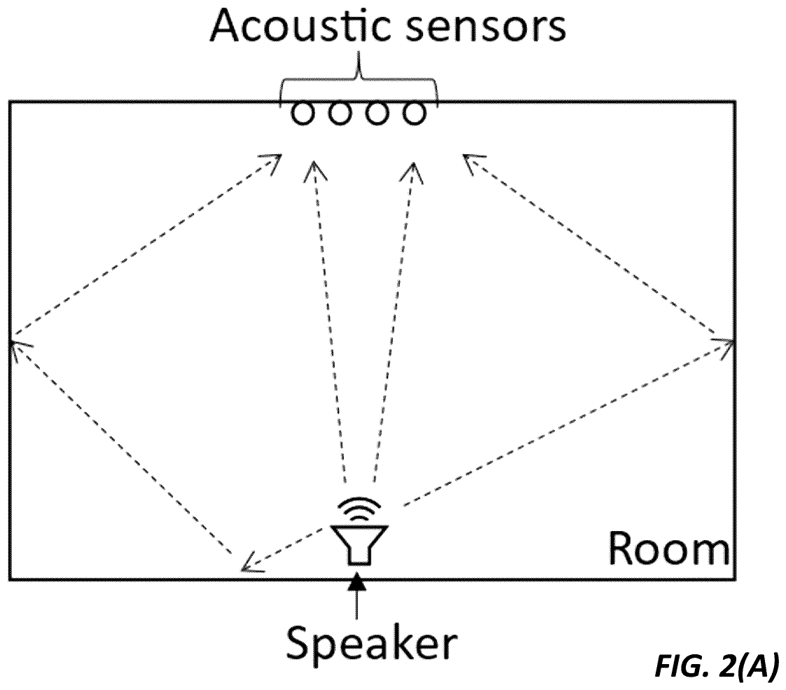

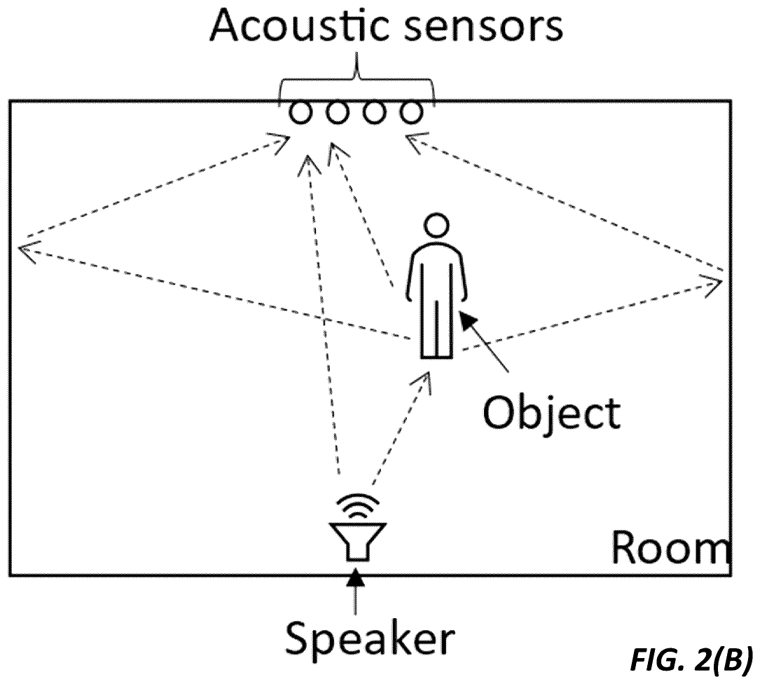

FIG. 2(A), and FIG. 2(B) are a series of schematic diagrams showing an illustrative propagation of sound in: FIG. 2(A), a vacant room; and FIG. 2(B), a room with an object to detect, according to aspects of the present disclosure.

With reference to that figure, there is shown in schematic form a sound propagating in a room. As shown in FIG. 2(A), when a fixed sound source (e.g., a speaker) emits a tone signal, i.e., sin(ωt), the fixed acoustic sensors (e.g., microphones) will receive signals mixed with direct paths and reflections. The received signal(s) depends both on the geometry of the room and the position of the speaker and sensors, which can be described as a transfer function h(R; p, sᵢ, t, f) from a speaker at position p to the i-th sensor at position sᵢ at time t and frequency f.

For simplicity, it is noted that the figure is shown as a 2D top view, where R represents the geometry of the room. Those skilled in the art will understand and appreciate that in 3D space, there are also reflections from the ceiling, floor, and other surfaces of indoor furniture. Therefore, the received signal at each sensor is a superposition of the signals from the direct path, reflections, and mirrored sources.

When using continuous tone signals as an acoustic source, such superposition will have a coherent interferometric effect, resulting in constructive or destructive interference at each sensor. Thus, the received signal at each sensor will have a different amplitude and phase at the tone frequencies. Such amplitude/phase difference between each sensor pair strongly depends on the geometry of the indoor environment. When an object, such as a person, enters the room, the geometry R will be changed, thus affecting the relative amplitude/phase difference between sensor pairs. By monitoring such kind of change, it is possible to detect and track the moving silent object in a 2D or 2D indoor space.

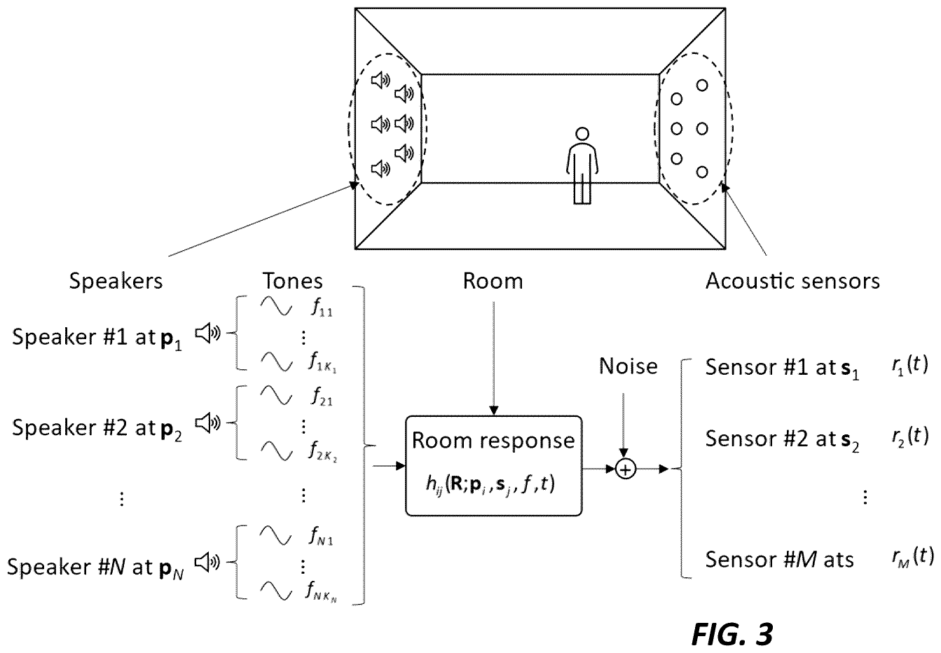

Based on this principle, we now note that a multi-input-multi-output (MIMO) scheme for detecting a silent object is made possible. FIG. 3 is a schematic diagram showing an illustrative MIMO scheme for silent-object detection using multiple tones according to aspects of the present disclosure.

In the MIMO scheme illustratively shown in this figure, there are N sound sources, such as speakers, emitting acoustic tone signals, and M sensors, such as microphones, receiving the acoustic signals. Each source may generate multiple tones, for instance, the i-th source emits Kᵢ tones at frequencies of fᵢ₁, fᵢ₂, . . . , f_{iK}_{ᵢ}. The transfer function of the room is expressed as hᵢⱼ(R; pᵢ, sⱼ, t, f). At the receiver side, each sensor obtained the tone signals from all the sources after the room transfer function, i.e.:

$${r}_{j} ( t ) = {\sum }_{i = 1}^{N} {\sum }_{l = 1}^{{K}_{i}} {h}_{ij} ( R ; {p}_{i} , {s}_{j} , t , {f}_{l} ) * {A}_{l} sin ( 2 π {f}_{l} t ) , j ∈ \{ 1 , 2 , … , M \} ,$$

where * denotes the convolution, Aₗ is the amplitude of the emitting sound at tone frequency fₗ.

In the data processing stage, the receiver has a set of the band-pass filter bank to separate different tone frequencies, i.e., rⱼ(t, fₗ). The variation of magnitude and phase variation at a frequency fₗ are then demodulated as complex amplitude αⱼₗ. In this way, M sensors output MK_{f} complex amplitudes, in which K_{f}=K₁+K₂+ . . . +K_{N} is the total number of tones, forming a complex amplitude vector of α=[α₁₁, . . . α_{MK}_{_{N}}], corresponding to frequency vector f=[f₁₁, . . . , f_{NK}_{_{N}}]. The relative intensity of relative phase information can be obtained by selecting a reference channel α_{ref}∈α and multiplying the complex vector with the reference conjugate, i.e.:

$$γ = \frac{{α}_{ref}^{+}}{{\vert {α}_{ref} \vert}^{2}} α .$$

To detect or localize whether there is an object in the room, we need to monitor the demodulated vector α or the relative vector γ. One of the naïve methods is to analyze the relative phase change ψ=∠γ and to track the variation over time. In the case of noise or weak signal amplitude, the relative phase change will fluctuate even if there is no object. Therefore, analyzing the “features” from the statistics of the ψ would be effective. Once the difference in features between the detected state and a vacant room is beyond a pre-configured threshold, it can be determined that there is an object or multiple objects in the room.

Our inventive method described above can be used for detecting whether there are objects in the room. Localizing the object, on the other hand, requires more information on the room transfer function. Though a finite element analysis (FEM) can be used to model the transfer function when the object is positioned at different locations, the calculation usually has high complexity and requires much computation resources. Therefore, pre-calibration can be implemented beforehand. For instance, the object to detect, such as a person, can stand in different positions pₒ, while the sensors record the corresponding relative phase ψ(pₒ) or its features. After recording sufficient positions, the system has a dataset containing the relative phase features. When a new object enters the room, the system will capture the relative phase, extract the features, and search for the closest possible location in the dataset. Such a process can be further accelerated by attaching an indoor localization device (such as an indoor GPS, UWB tracker etc.) to the object so that the positions can be automatically recorded and mapped with the relative phase feature.

Alternatively, the relationship between the position of a silent object and the delay between sensor pairs can be established with the help of artificial intelligence (AI). The pre-calibration dataset can be used as the training data for the machine-learning model such as a deep neural network (DNN) or a convolution neural network (CNN). The input of the model would be the relative phase vector ψ(pₒ), the relative intensity vector, or both. The label is the ground truth position pₒ. After the training, the model can localize the object when receiving a new relative phase vector.

The description above only shows the scenario for a single room. For realist indoor applications, there would be multiple rooms that need to be monitored. Therefore, many sensors are needed for the MIMO scheme, raising the challenges of sensor synchronization, data transmission, and maintenance. Therefore, in this IR we also disclose a distributed acoustic sensing (DAS)-based solution for the multi-room MIMO monitoring. The DAS is a distributed sensing system that utilizes optical fiber as the sensing media to capture acoustic signals. Each segment of the fiber can be used as an independent acoustic sensor. For example, a single DAS system can easily support 50 km of fibers. Taking the typical gauge length of 5 meters into account, then the fiber is equivalent to ten thousand acoustic sensors. This is an incredible number of sensors that electrical methods can never compete with. Moreover, the cheap price of optical fiber makes the cost of each sensor less than $1. This makes the fiber system very cost-effective.

Last, one DAS system can manage all these sensors by interrogating through optical pulses, which enables the centralized processing of all the acoustic data.

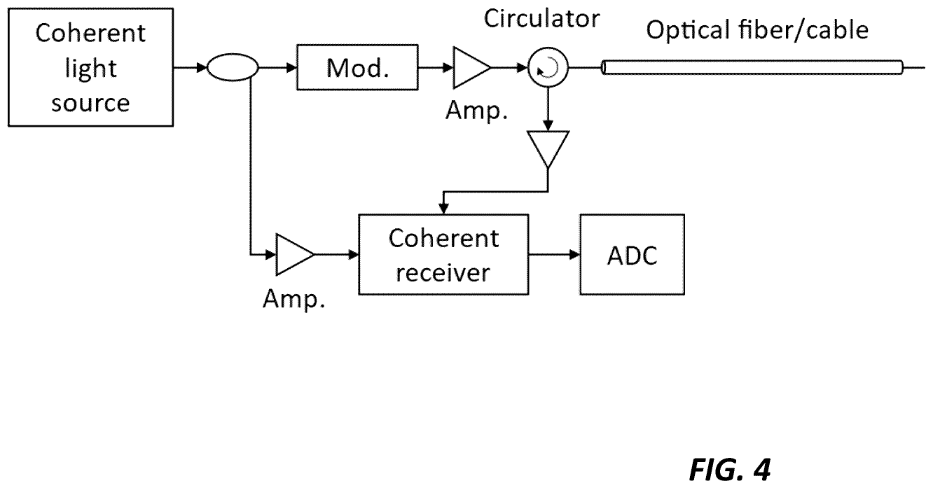

FIG. 4 is a schematic block diagram showing an illustrative structure of a DAS system according to aspects of the present disclosure.

The illustrative structure of a DAS system shown in the figure, include a coherent laser source, coupler, modulator (Mod.), amplifier (Amp.), fiber-optic circulator, coherent receiver, and digital signal processing (DSP). The coherent laser source generates a coherent laser wave, which is modulated into optical pulses by the modulator (e.g., EOM, AOM, etc.). The pulse duration is set according to the desired spatial resolution (SR). An amplifier (e.g., EDFA, SOA, etc.) is optional for adjusting the optical pulse power to the desired level. The fiber-optic circulator device (e.g., circulator, 3-dB coupler, etc.) transmits the optical pulses into the output fiber and collects the Rayleigh backscattering signal. A coherent receiver (e.g., ICR) detects the returned optical signal and converts it into electrical signals. An acquisition device (e.g., ADC) digitizes the electrical signals from the receiver and transfers them to a processor or computer for digital signal processing (DSP). A DAS system has at least one output optical port. It can also have multiple output optics ports through an optical switch/router.

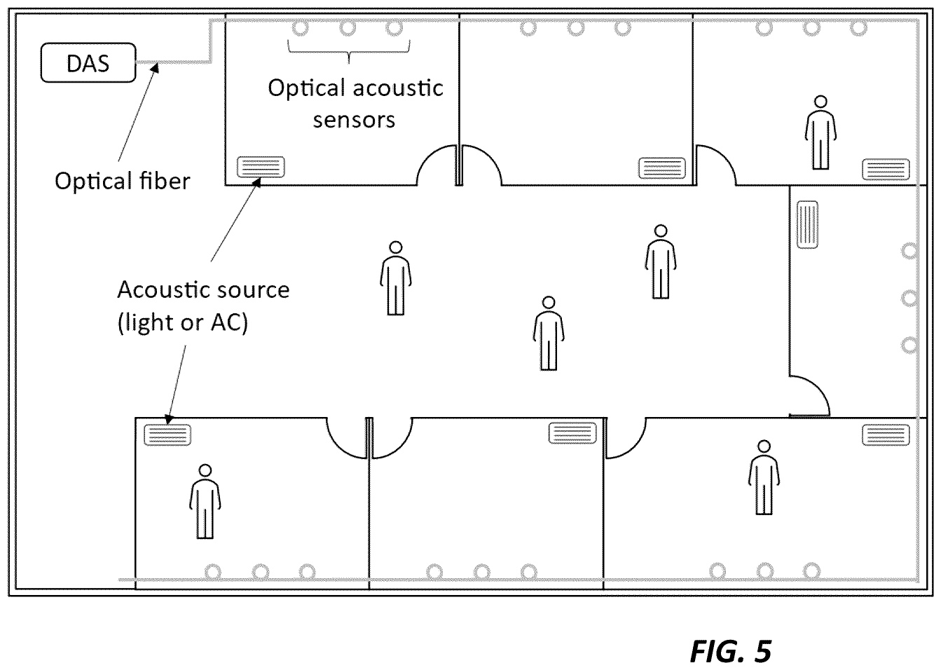

FIG. 5 is a schematic diagram showing an illustrative top view of an indoor object detection/localization scheme for multiple rooms according to aspects of the present disclosure.

In this figure, we illustrate a few office rooms as an example, while the scheme is expandable for larger floor plans. The optical fiber is deployed across each office to be monitored. The optical fiber can be deployed inside ceilings or walls, or other places.

A few segments of the fiber (i.e., the sensing segments) may need to be attached to the wall or ceiling to ensure it can detect the sound with sufficient SNR, while other segments of the optical fiber (i.e., the connecting segments) can be put deeper to connect the sensing segments. In this case, N sensing segments of fiber are equivalent to N optical acoustic sensors. To enhance the SNR, the sensing segments can also be wrapped as fiber coils or over an acoustic enhancer (AE), such as the mandrels or the thin-wall cylindrical transducers made of elastic material.

The sound source in each room could be the active speakers which generate tone signals. When privacy is a concern in the offices, the tone frequencies can be selected to avoid the voice band (300-3400 Hz according to the definition in telephony). When AEs are used as acoustic sensors, the mandrel of the transducer can be designed to be sensitive to a particular frequency, i.e., the resonance frequency, and incentive to other frequencies, especially in the voice band. Therefore, the AEs can only have sufficient sensitivity to detect the designed frequencies but cannot hear the people's talking or chatting at the voice band. In this way, privacy in the workspace can be protected and guaranteed. Alternatively, it is also possible to use ambient sounds as the acoustic source, such as the buzzing sound from the power transformer of the office lights, or the humming sound from the AC vents or fans. These ambient sounds are usually below 300 Hz, which is compliant with the privacy concern.

The acoustic signals picked by the multiple optical acoustic sensors will be interrogated via one DAS system. The DAS will proceed with all the MIMO data of each room with the similar DSP steps as described above.

Therefore, it is possible to know whether the rooms are vacant or occupied, or even track the movement of the object inside a room with proper pre-calibrations or sufficient training dataset. Such information can be used for weather and light control in a large workspace. If a room is detected to be vacant, then the AC and lighting system may be turned off to save energy consumption, which is beneficial to reduce carbon emissions and achieving the carbon-neutral target.

To verify the feasibility of the principle, we conduct preliminary experiments using DAS and optical fiber.

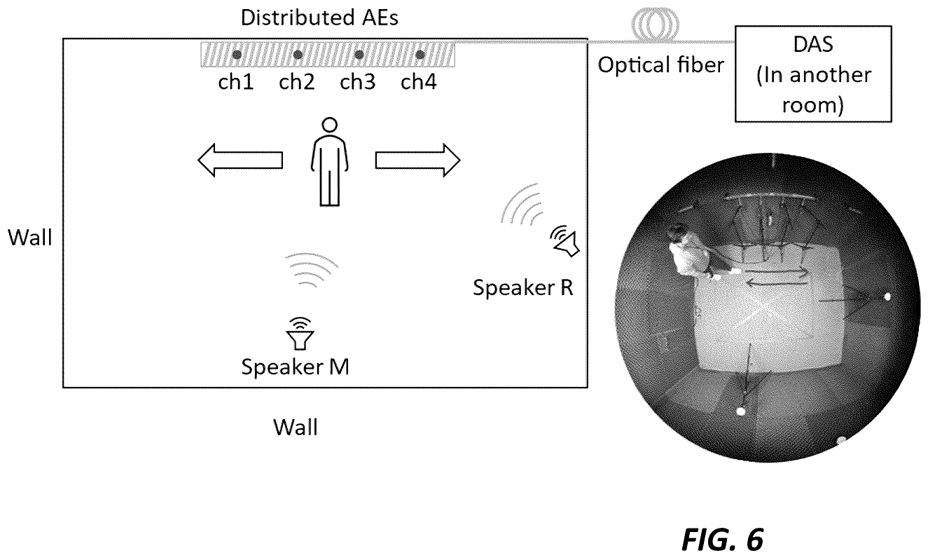

FIG. 6 is a schematic diagram with photo-illustration showing an illustrative setup for our preliminary experiments on systems and methods according to aspects of the present disclosure.

As shown in FIG. 6, a 1-m long distributed acoustic enhancer (AEs), which is made by wrapping the optical fiber around a long thin-wall cylindrical tube, is used to form four channels (ch1, ch2, ch3, ch4) equidistantly. The tube is mounted on one of the walls, connecting to a DAS which is in another room. Two speakers are used as acoustic sources, one is on the right side (denoted as Speaker R), while another one is in the middle (i.e., Speaker M). The DAS captures the acoustic signals from four channels while a person is walking around in the room.

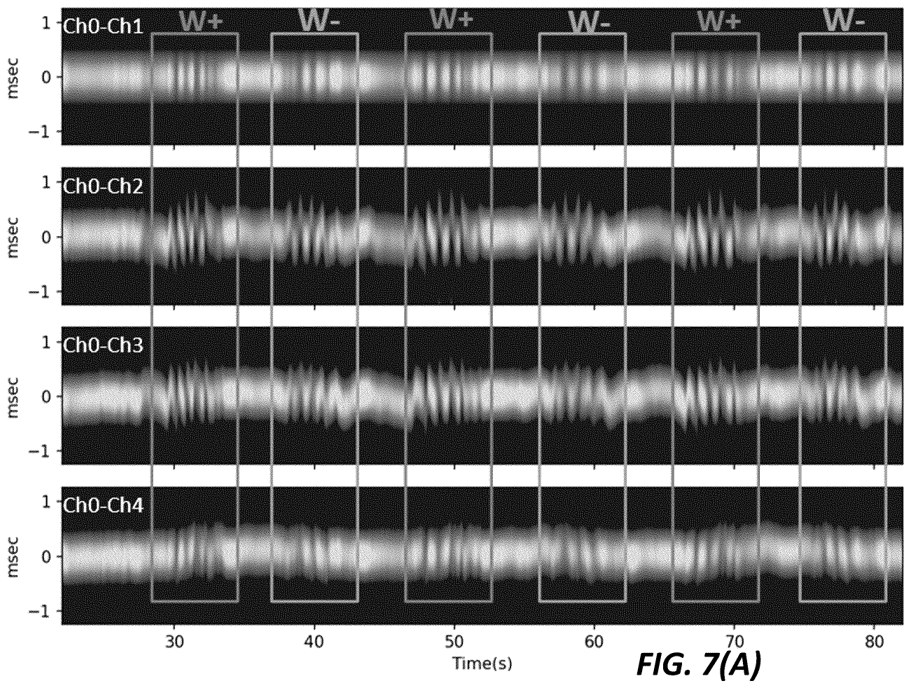

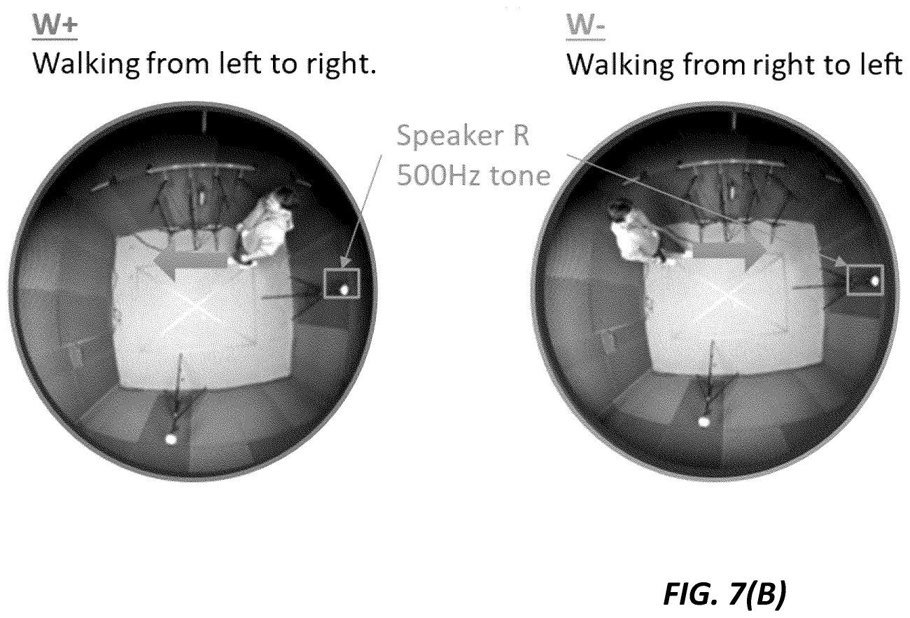

The received signals proceeded with the method described in this IR. Results of the relative phase variation are given by the correlograms, as shown in FIG. 7(A) and FIG. 7(B) show correlograms of relative phases with 500 Hz tone @ speaker R according to aspects of the present disclosure.

In this experiment, Speaker R is emitting a tone signal at 500 Hz while the person is walking around. It is found that when the person is walking from left to right (i.e., “W+” direction), the patterns of relative phase are quite repeatable. When the person is walking from right to left (i.e., “W−” direction), it appears to be another pattern but is still quite repeatable. These patterns are due to the change of the geometry R when the person is at a different location. The tones are reflected by the person, combined with other signals from direct paths and wall/ceiling reflections, thereby resulting in the variation of relative phase patterns.

Experiments with another speaker (Speaker M) are also conducted. We use Speaker M to emit a 300-Hz tone and repeat the experiment of walking in both W+ and W− directions. It is shown that when using a 300-Hz tone, the relative phase patterns appear a different shape but are still repeatable. This is because the room transfer function h (R; p, sᵢ, t, f) is frequency dependent. Moreover, we use both speakers to emit two tones (300 Hz and 500 Hz) simultaneously and utilize a digital filter to separate them in the DSP stage. Results show that after frequency filtering, the pattern is almost the same as the ones from only one tone. These results verify the feasibility of the principle and pave the way for future applications.

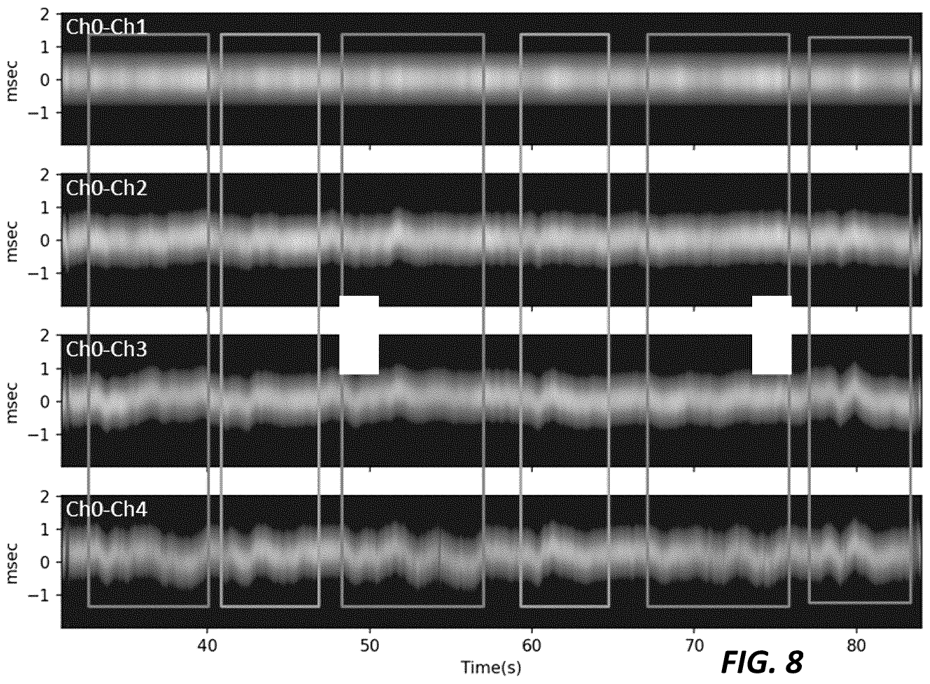

FIG. 8 shows correlograms of relative phases with 300-Hz tone @ speaker M according to aspects of the present disclosure.

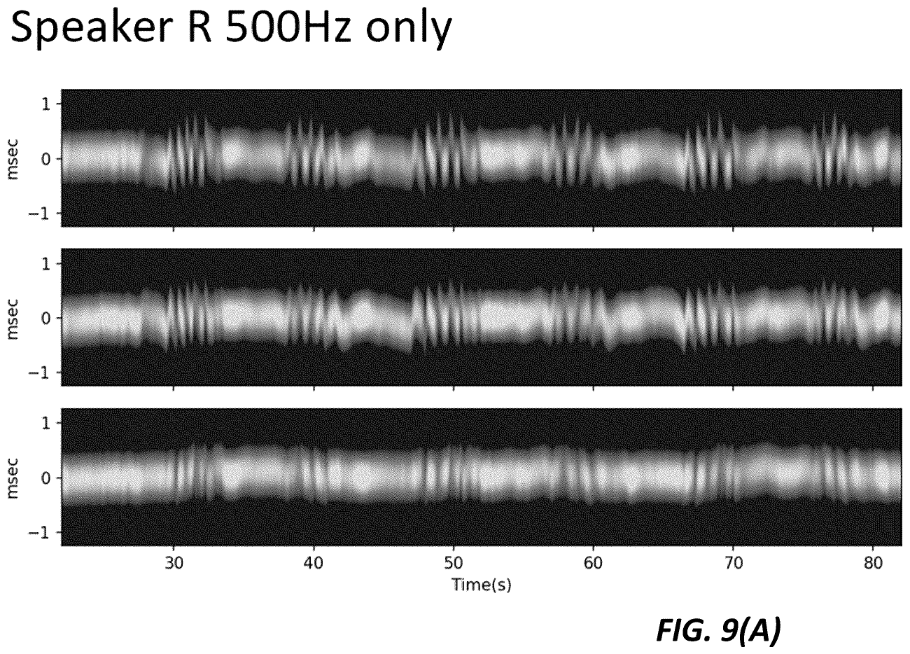

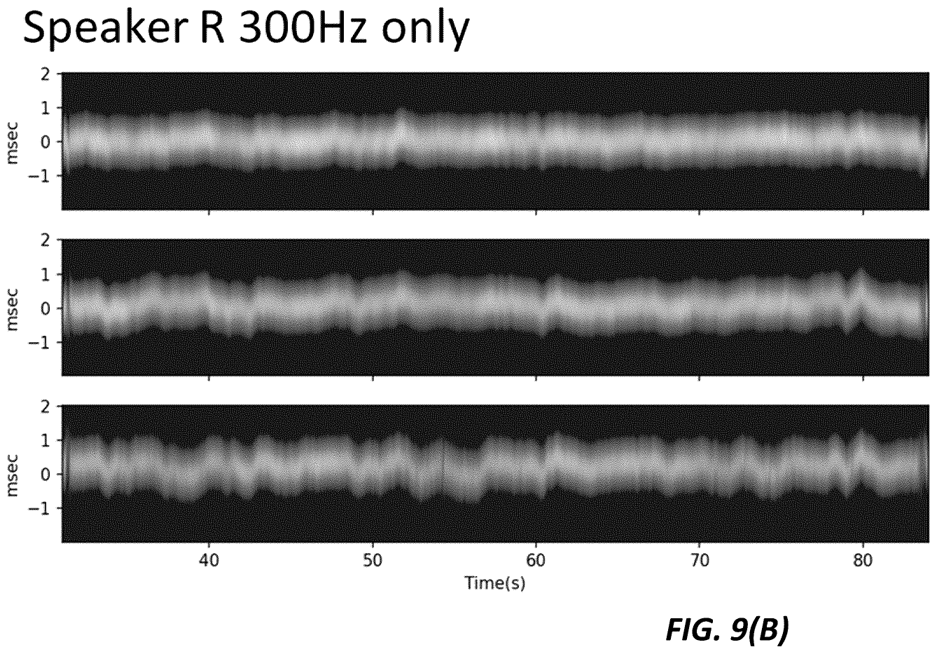

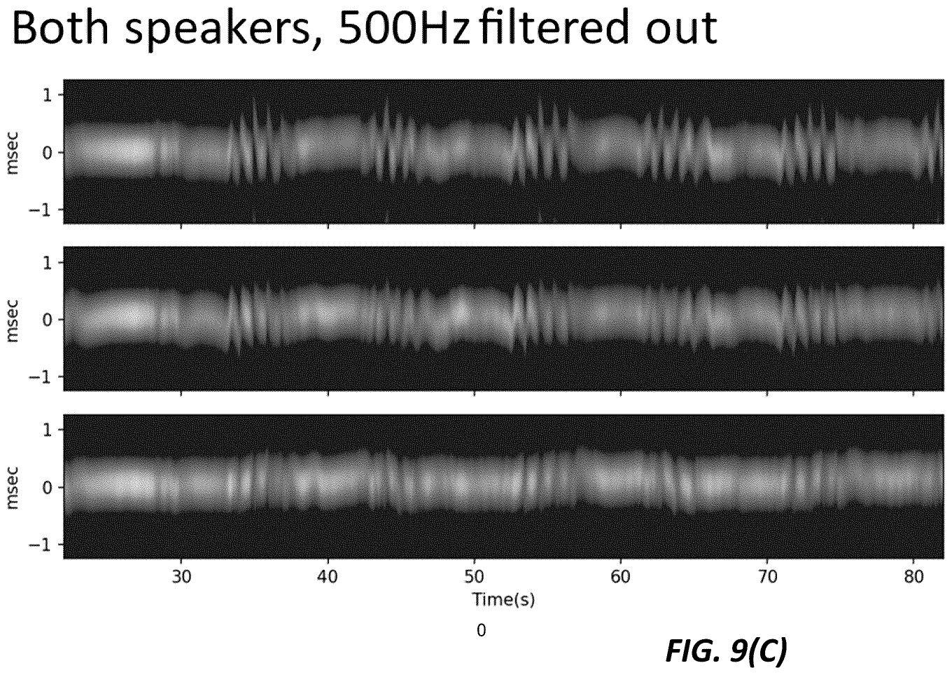

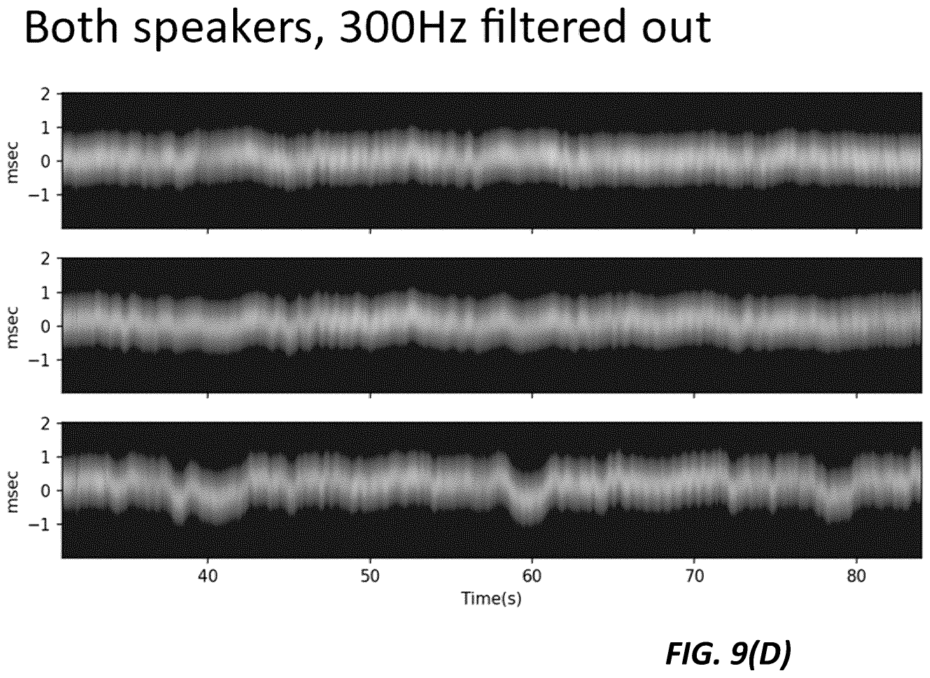

FIG. 9(A), FIG. 9(B), FIG. 9(C), and FIG. 9(D) are a series of correlograms in which; FIG. 9(A) is for Speaker R 500-Hz only; FIG. 9(B) is for Speaker R 300-Hz only; FIG. 9(C) is for both Speakers, 500-Hz filtered; and FIG. 9(D) is for both Speakers, 300-Hz filtered; according to aspects of the present disclosure.

Advantageously, prior art uncoded and coded DFOS systems may be employed with systems and methods according to aspects of the present disclosure.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

A generalized arrangement and operation of a distributed fiber optic sensing system may advantageously include artificial intelligence/machine learning (AI/ML) analysis. Operationally, an optical sensing fiber that in turn is connected to an interrogator and the interrogator may include a coded DFOS system that may employ a coherent receiver arrangement known in the art.

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DVS allows for continuous monitoring over long distances, but instead of measuring temperature, it measures vibrations and sounds along the fiber.

DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As the technology continues to develop, DAS/DVS is expected to become even more widely used in various fields where continuous and sensitive acoustic/vibration monitoring is crucial.

With the above in mind, we note that distributed fiber optics sensing (DFOS) continues to gain more interest as technology advances to use existing telecom fiber network for various sensing applications, such as traffic monitoring, public safety surveillance, road condition monitoring, and so on. Backscattered fiber sensing, including Rayleigh backscattering for distributed acoustic sensing (DAS), Raman backscattering for distributed temperature sensing (DTS), and Brillouin optical time domain reflectometer (BOTDR) for fiber strain and temperature sensing, are widely deployed and have tens of kilometers sensing distance.

While we have presented our inventive concepts and description using specific examples, our invention is not so limited. Accordingly, the scope of our invention should be considered in view of the following claims.

1. A multiple-input multiple-output (MIMO) acoustic detection and localization method comprising:
generating continuous tones from multiple sound sources located a different positions in an area;
synchronously capturing sound by multiple acoustic sensors located at different positions in the area;
determining phase differences of selected tones in sensor pairs; and
determining a locality of an object in the area from the determined phase differences.

2. The method of claim 1 wherein the area is an indoor area.

3. The method of claim 2 wherein the indoor area is a confined space.

4. The method of claim 3 wherein an object enters or moves within the area.

5. The method of claim 4 wherein the object enters or moves silently.

6. The method of claim 1 wherein the multiple sound sources comprise N speakers the multiple acoustic sensors comprise M microphones.

7. The method of claim 1 wherein the multiple sound sources generate multiple tones such that the i-th source emits K/tones at frequencies fᵢ₁, fᵢ₂, . . . f_{iKi}.

8. The method of claim 7 wherein each individual sensor of the multiple acoustic sensors sense tone signals from all the multiple sound sources in the area.

9. The method of claim 8 wherein the determined phase differences includes analyzing relative phase change features from statistics of the relative phase change.

10. The method of claim 9 further comprising pre-calibrating the area by positioning an object to be detected in the area while the multiple acoustic sensors sense a relative corresponding phase vector (ψ(pₒ)), or its features.

11. The method of claim 10 wherein a relationship between a silent object and a delay between sensor pairs is established by artificial intelligence (AI) in which a pre-calibration dataset is used as training data for a machine-learning model such as a deep neural network (DNN) or a convolutional neural network (CNN).

12. The method of claim 11 in which the multiple acoustic sensors are part of a DFOS optical fiber.
